(19) United States
(12) Patent Application Publication
(10) Pub. No.: US 2013/0247702 A1
(43) Pub. Date: Sep. 26, 2013

(54) CONTROL DEVICE FOR INDUSTRIAL MACHINERY

(71) Applicants: Germán ETXEGARAI MARTINEZ, San Sebastian (Guipuzcoa) (ES); Sergio ALONSO ROSCO, San Sebastian (Guipuzcoa) (ES); Luis Alberto BOTANZ HOLKE, San Sebastian (Guipuzcoa) (ES)

(72) Inventors: Germán ETXEGARAI MARTINEZ, San Sebastian (Guipuzcoa) (ES); Sergio ALONSO ROSCO, San Sebastian (Guipuzcoa) (ES); Luis Alberto BOTANZ HOLKE, San Sebastian (Guipuzcoa) (ES)

(21) Appl. No.: 13/796,042

(22) Filed: Mar. 12, 2013

(30) Foreign Application Priority Data
Mar. 20, 2012 (EP) 12382100.1

(51) Int. Cl. G05G 1/04

(52) U.S. Cl. CPC G05G 1/04
USPC 74/471 XY

(57) ABSTRACT

A control device for industrial machinery that includes a conventional mini-joystick comprising a drive shaft; a casing at least partially covering said the conventional mini-joystick; a plate element resting on the casing, the plate element including a central through hole allowing the passage of the drive shaft; and a hollow tubular runner internally comprising the drive shaft such that when the runner moves the drive shaft likewise moves; wherein the interaction between the runner and the plate element make the device highly sensitive when being used in industrial environments, and where the use of a conventional mini-joystick results in a small and portable device.

### TECHNICAL FIELD OF THE INVENTION

The present invention relates to a control device for industrial machinery; where said device has an application in controlling cranes, lifting machinery and the like, belonging to the industrial sector.

The purpose of the control device for industrial machinery object of invention is to adapt a mini-joystick (for example a conventional mini-joystick such as those used in computers or consoles) in industrial and therefore aggressive environments with respect to the device and its correct operation, such that it is small-sized and capable of precisely transmitting the position of the drive shaft of the mini-joystick to the operator, all with simple and economical elements, forming an ergonomic and resistant device according to said applications in industrial environments.

### BACKGROUND OF THE INVENTION

By way of introduction, control devices used today in controlling cranes, lifting machinery or the like, are large-sized joystick type control devices, and are aimed at being mounted in desk type radio control transmitters because small joystick devices, which are more suited to being installed in pushbutton type portable control transmitters, they do not have the ergonomics and robustness necessary for correctly operating and controlling the crane type machinery or the like.

Various applications relating to various control devices for industrial environments are thus known, see for example:

International application with publication number WO-83/00398, where a large-sized joystick which can be manually controlled by the operator is described; where the size of its components complicates both its transport and operator-oriented sensitivity for operating the lifting machinery; and where additionally the elements forming it are very particular elements that are therefore expensive to manufacture and replace in the event of a breakdown.

European patent application with publication number EP-999487; where a joystick type control device with defined and specific positions is described; where said device comprises a large-sized surrounding structure and a plurality of inner elastic elements defining the fixed positions of said device, having drawbacks similar to the aforementioned international application with respect to being large-sized and with high-cost and maintenance custom-made elements, and where it additionally requires a large number of elastic elements which make the device shown even more expensive.

United States patent application with publication number US-2004/0095320, wherein a lever type joystick device is described which, like the aforementioned applications, is large-sized, offers scarce ergonomics and has a plurality of uniquely designed elements that are therefore expensive to manufacture and maintain.

Korean patent application with publication number KR-2004/0039108, wherein a small-sized joystick type control device suitable for being installed in a pushbutton type radio control transmitter is described, having the advantages of being ergonomic and easily transportable, but lacking suitable strength for industrial environments due to the fragility of the operating or drive shaft of said device, such that it is not adapted to the field of application of the device object of invention.

Finally, United States patent application with publication number US-2010/0201622 should be mentioned, wherein a mini-joystick type control device for industrial environments is described, wherein each device comprises a control lever and a plurality of magnetic elements for detecting the positioning of the control lever, overcoming some of the aforementioned drawbacks, but with the problem of the lack of ergonomics and sensitivity of each lever, the need to have a table for arranging the plurality of mini-joystick devices, and the increased cost of the device as it requires magnetic positioning elements for control thereof.

In view of the mentioned background and the existing drawbacks relating to the large-sized joystick devices lacking ergonomics and having a high manufacturing and maintenance cost, a new control device for industrial machinery is needed which prevents the aforementioned drawbacks in that it is small-sized, capable of being portable, formed by a plurality of easy to maintain simple and economical elements, and capable of being used in aggressive environments such as in the industrial sector and lifting machinery sector.

### DESCRIPTION OF THE INVENTION

The present invention relates to a control device for industrial machinery which notably solves the drawbacks described above and allows adapting a conventional mini-joystick for use in industrial environments and for controlling lifting machinery and for general use, such that a handling-resistant and ergonomic device is provided.

The control device for industrial machinery proposed by the invention comprises:

a mini-joystick comprising a drive shaft. The mini-joystick is preferably a conventional mini-joystick of the type found on the market today;

a casing at least partially covering said mini-joystick;

a plate element resting on the casing, where said plate element comprises a central through hole allowing the passage of the drive shaft through said central through hole; and

a hollow tubular runner internally comprising the drive shaft such that when the runner moves the drive shaft likewise moves; where one of the bases of the runner comprises a radial flaring, and where said radial flaring can rest on a surface belonging to the plate element.

Novel technical features include the combination of the runner in contact with the plate element because the runner is directly linked with the movement of the drive shaft of the mini-joystick, and when the runner moves, it comes into contact with specific areas of the plate element which can comprise a series of geometries interacting with the runner and are perceived by the user handling the device object of invention, such that even when the user is wearing safety gloves or the like, he is capable of very easily perceiving and differentiating the position of the drive shaft of the mini-joystick.

It is additionally observed that the most complex element of the entire device, and therefore the most expensive, is the mini-joystick which will preferably be a conventional mini-joystick which are easily found on the market and have an application in very diverse uses such as a joystick for video consoles, computers, for handling onboard vehicle computers, mobile telephones, etc. Therefore, the cost is not high and does not involve making a particular and unique joystick particular for the device object of invention, unlike in the mentioned background.

In view of the use of a mini-joystick, it is observed that the overall size of the device object of the invention will be substantially much smaller than control devices for machinery used today in the industrial sector, with the subsequent advantage of being able to be easily transported and be included in conventional remote control pushbutton devices.

It must be taken into account that the plate element can be formed from, or be part of, the casing itself such that they form a single element and the overall manufacturing cost of the device object of invention is reduced.

With respect to the interaction of the runner with the plate element, various configurations that can be combined with one another are contemplated.

A first configuration contemplates that the surface of the plate element in contact with the radial flaring is smooth, thereby achieving continuous movement of the drive shaft throughout 360°, without any interference. This is preferably valid for non-aggressive environments, such that the user does not need safety gloves that can reduce sensitivity of perceiving the movement of said drive shaft.

A second configuration contemplates that the surface of the plate element in contact with the radial flaring of the runner comprises at least one notch in a radial direction, such that a continuous movement of the drive shaft throughout 360° is achieved but it results in a stimulus that the user perceives every time the radial flaring passes over said at least one notch; being able to contemplate, for example, a notch every 45° so that the user perfectly perceives the position of the operating shaft without needing to remove respective safety gloves; and where each notch can additionally comprise at least one recess perpendicular to it, defining steps perceivable by the user and considerably increasing the degree of sensitivity of the device.

A third configuration contemplates that the surface of the plate element in contact with the radial flaring of the runner comprises at least one circumferential groove, such that a continuous movement of the drive shaft throughout 360° is achieved but it results in a stimulus differentiating two areas along a radial path such that, for example, said at least one circumferential groove can demarcate two different speeds to be chosen by the user, which are very easily perceived.

A fourth configuration contemplates that the surface of the plate element in contact with the radial flaring of the runner comprises a geometric configuration in sectors, such that the operating shaft rapidly tends to move towards the area limited by the sectors, there preferably being four sectors in the form of a four leaf clover rapidly and precisely demarcating the preferential north-south-east-west positions.

A fifth configuration contemplates that the surface of the plate element in contact with the radial flaring of the runner comprises a configuration of sectors defined by radial notches, with the particularity that in the preferential directions (for example N, S, E, W) the two contiguous notches defining the sector of the preferential direction are separated by an angle greater than the notches corresponding to non-preferential directions (for example NW, NE, SE, SW). For example the notches demarcating the sectors of preferential directions can be separated by an angle greater than 47.5° (defining an angular sector greater than 47.5° in each preferential direction) and the notches demarcating non-preferential sectors can be separated by an angle of less than 42.5° (defining an angular sector in each non-preferential direction less than 42.5°). This design conveys to the user a continuous and step-less sensation in each of the possible operating directions and better guiding in the preferential directions.

A sixth configuration contemplates that the surface of the plate element in contact with the radial flaring comprises a series of double notches in a radial direction, i.e., each notch comprises two ramps or steps allowing the user to have a sensation of two steps in each of the operating directions.

The preceding configurations are complementary to one another according to the machinery to be operated and the customer's needs, contemplating the option of the surface of the radial flaring of the runner in contact with the surface of the plate element being smooth.

As an alternative embodiment, the possibility of the surface of the radial flaring of the runner in contact with the surface of the plate element comprising at least one protrusion, whether in a radial or circumferential direction, is contemplated, such that the plate element comprises a smooth surface in contact with the radial flaring of the runner, and it is this radial flaring having said at least one protrusion intended for indicating specific positions or speeds of the device object of invention.

The possibility of the device comprising an operating knob which can be coupled on the runner is contemplated, such that the knob is directly linked with the movement of the runner and the movements are also transmitted in both directions: from the operating knob to the drive shaft, and from the irregularities exiting both in the plate and in the runner to said operating knob for being perceived by the user.

One of the options is based on the operating knob comprising a plurality of merlon or peak type geometric irregularities at its upper end to assure proper gripping of the operating knob by the user.

Another option is for the operating knob to comprise a series of protrusions on its side surface, smooth areas being defined between two contiguous protrusions such that when supporting the operating finger in a well demarcated area or surface (protrusion or smooth area) the force can be better directed in the suitable direction. The protrusions can be configured such that they coincide with the preferential directions and the smooth areas coincide with the non-preferential directions or vice versa according to user preferences.

The knob can also incorporate a central lug in correspondence with the drive shaft which allows defining a good support surface for the user's finger.

It additionally comprises at least one elastic element which is attached at one end to the runner, and is attached at the other end to the operating knob, such that it allows the backward movement of the operating knob on which the operator can act with his/her thumb for activating/deactivating characteristic functions of the mini-joystick.

Finally, the possibility of an elastic part (dust cover) at least partially covering the device object of invention is contemplated, providing mechanical strength and leak-tightness fundamental for aggressive work environments on which the device of invention is focused.

Therefore, according to the described invention, the control device for industrial machinery proposed by the invention constitutes an advance in control devices known until now and solves in a fully satisfactorily manner the aforementioned drawbacks in that it provides a small-sized device, capable of being portable, formed by a plurality of easy to maintain simple and economical elements, and capable of being used in aggressive environments such as in the industrial sector and lifting machinery sector.

### DESCRIPTION OF THE DRAWINGS

To complement the description that is being made and for the purpose of aiding to better understand the features of the invention according to a preferred practical embodiment thereof, a set of drawings is attached as an integral part of said description in which the following has been depicted with an illustrative and non-limiting manner:

FIG. 1 shows a schematic view of the mini-joystick.

FIG. 2 shows a schematic view of the casing covering part of the mini-joystick.

FIG. 3 shows a schematic view of the device shown in FIG. 2, to which the plate element has been coupled.

FIG. 4 shows a series of possible embodiments of the plate element.

FIG. 5 shows a schematic view of the device shown in FIG. 3, to which the tubular runner has been coupled.

FIG. 6 shows a schematic view of the device shown in FIG. 5, to which a spring has been coupled inside the tubular runner.

FIG. 7 shows a schematic view of the device shown in FIG. 6, to which an operating knob has been coupled in contact with the spring, said knob being operated by the user.

FIG. 8 shows a schematic view of the device shown in FIG. 7, to which an elastic part (dust cover) has been coupled covering and protecting it.

FIG. 9 shows a schematic view of a second variant of the operating knob.

### PREFERRED EMBODIMENT OF THE INVENTION

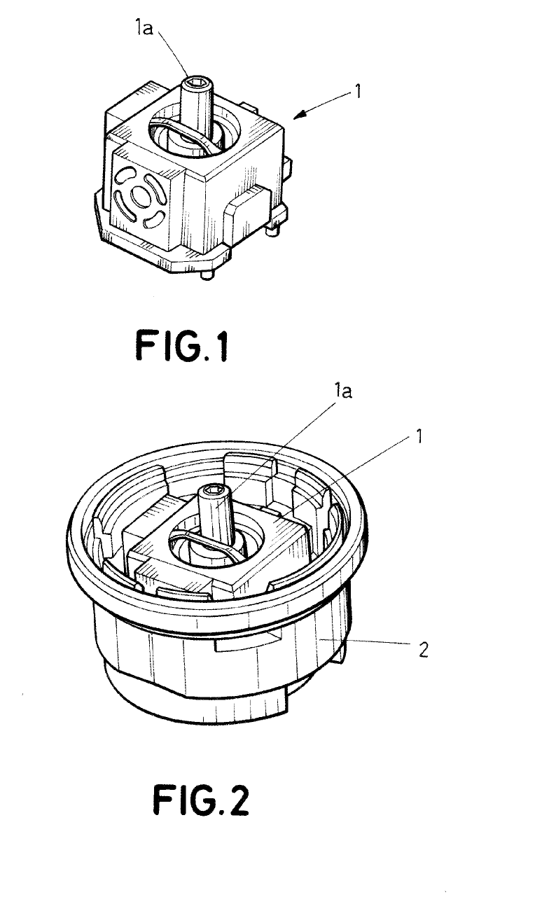

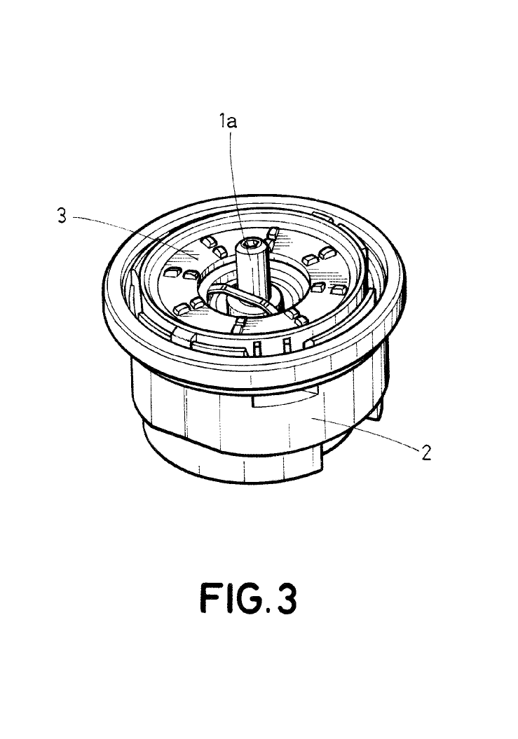

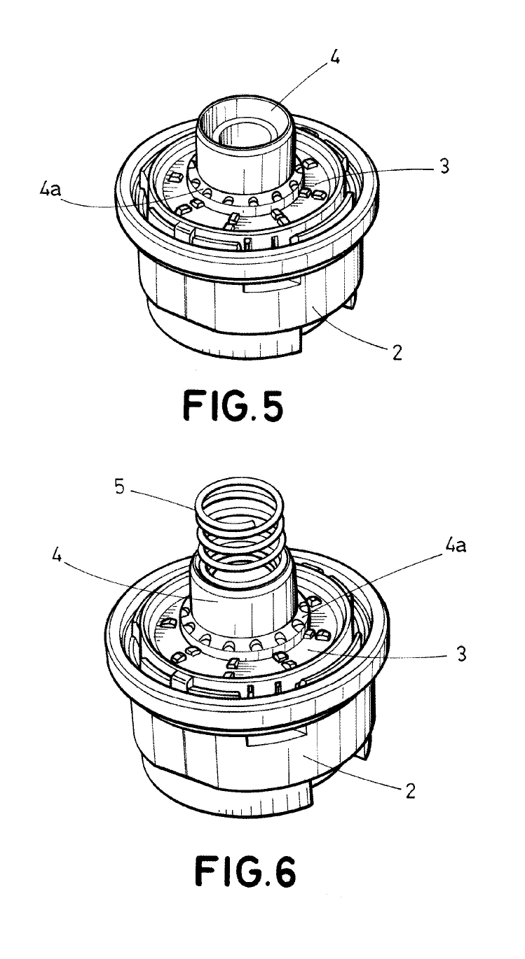

In view of the sequence of FIGS. 1 to 9, it can be observed how one of the possible embodiments of the control device for industrial machinery proposed by the invention comprises:
a conventional mini-joystick (1) comprising a drive shaft (1a);
a casing (2) partially covering said conventional mini-joystick (1), leaving the upper area thereof free;
a plate element (3) resting on the casing (2), where said plate element (3) comprises a central through hole (3b) allowing the passage of the drive shaft (1a) through said central through hole (3b),
a hollow tubular runner (4) internally comprising the drive shaft (1a), such that when the runner (4) moves, the drive shaft (1a) likewise moves; where one of the bases of the runner (4) comprises a radial flaring (4a), and where said radial flaring (4a) is resting on a surface (3a) belonging to the plate element (3);
an operating knob (6) which is coupled on the runner (4;
a spring (5) which is attached at one end to the runner (4) and is attached at the other end to the operating knob (6); and
an elastic part (7) at least partially covering the device and giving it mechanical strength and leak-tightness.

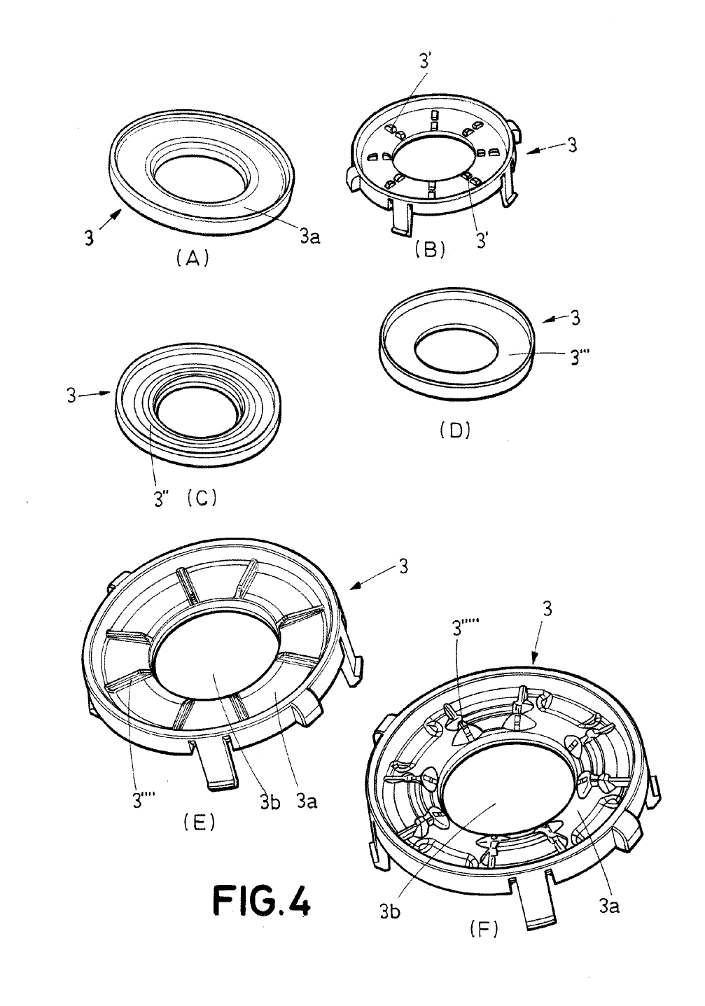

FIG. 4 shows a series of possible embodiments of the plate element (3).

In FIG. 4a it is observed how the surface (3a) of the plate element (3) in contact with the radial flaring (4a) is smooth.

In FIG. 4b it is observed how the surface (3a) of the plate element (3) in contact with the radial flaring (4a) comprises eight notches (3′) in a radial direction and separated from one another by an angle of 45°, where each notch (3′) comprises a recess perpendicular to said notch (3′).

In FIG. 4c it is observed how the surface (3a) of the plate element (3) in contact with the radial flaring (4a) comprises a circumferential groove (3″) demarcating two positions of the drive shaft in a radial direction.

In FIG. 4d it is observed how the surface (3a) of the plate element (3) in contact with the radial flaring (4a) comprises a geometric configuration formed by four sectors (3′″) in the form of a four leaf clover and defining the north-south-east-west positions.

In FIG. 4e it is observed how the surface (3a) of the plate element (3) in contact with the radial flaring (4a) comprises eight radial notches (3″″) defining eight sectors. In the preferential directions (for example N, S, E, W) the two contiguous notches defining the sector of the preferential direction are separated by an angle greater than 47.5° whereas the notches corresponding to non-preferential directions (for example NW, NE, SE, SW) are separated by an angle of less than 42.5°. In other words, there are four larger sized sectors in the preferential directions and four smaller sectors in the non-preferential directions. This design conveys to the user a continuous and step-less sensation in each of the eight possible operating directions and better guiding in the preferential directions.

In FIG. 4f it is observed how the surface (3a) of the plate element (3) in contact with the radial flaring (4a) comprises four double notches (3′″″) in the radial direction defining eight sectors. Specifically, each notch comprises two ramps or steps allowing the user to have a sensation of two steps in each of the eight possible operating directions. These notches can be separated by different angles as in the embodiment of FIG. 4e defining preferential operating sectors and non-preferential operating sectors.

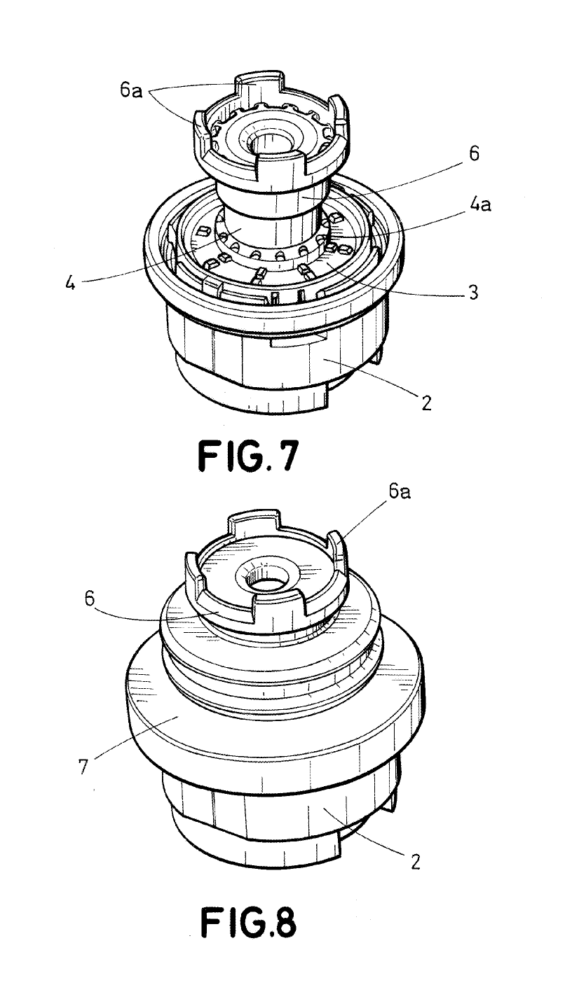

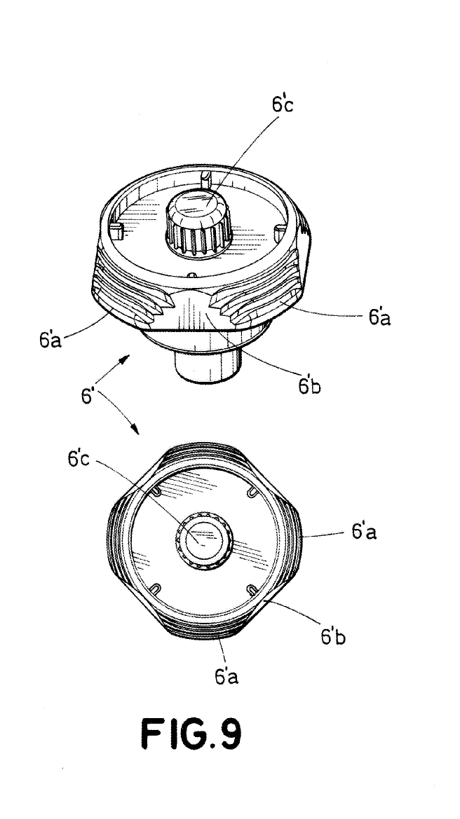

An embodiment is depicted in FIG. 7 in which the operating knob (6) comprises four merlons (6a) improving the gripping of said operating knob (6) by the user. Another embodiment is depicted in FIG. 9 in which the operating knob (6′) comprises a series of protrusions (6′a) on its side surface, contiguous, smooth areas (6′b) being defined between two protrusions (6′a) such that when the operating finger rests on a protrusion (6′a) or on a smooth area (6′b) it allows better directing the force in the suitable direction. The protrusions (6′a) can be configured such that they coincide with the preferential directions and the smooth areas (6′b) coincide with the non-preferential directions or vice versa according to user preferences.

The operating knob (6′) can also incorporate a central lug (6′c) in correspondence with the drive shaft (1a) which allows defining a good support surface for the user's finger.

In view of this description and set of drawings, the person skilled in the art will understand that the embodiments of the invention that have been described can be combined in many ways within the object of the invention. The invention has been described according to several preferred embodiments thereof, but it will be obvious for the person skilled in the art that multiple variations can be introduced in said preferred embodiments without exceeding the object of the claimed invention.

1. A control device for industrial machinery comprising:
a mini-joystick (1) comprising a drive shaft;
a casing at least partially covering said mini-joystick; and
a plate element resting on the casing, wherein said plate element comprises a central through hole allowing the passage of the drive shaft through said central through hole, and
a hollow tubular runner internally comprising the drive shaft such that when the runner moves the drive shaft likewise moves; wherein one of the bases of the runner comprises a radial flaring, and said radial flaring can rest on a surface belonging to the plate element.

2. A device according to claim 1, wherein the surface of the plate element in contact with the radial flaring is smooth.

3. A device according to claim 1, wherein the surface of the plate element in contact with the radial flaring of the runner comprises at least one notch in a radial direction.

4. A device according to claim 3, wherein said at least one notch, in a radial direction and belonging to the surface of the plate element in contact with the radial flaring of the runner, comprises at least one recess perpendicular to said at least one notch.

5. A device according to claim 1, wherein the surface of the plate element in contact with the radial flaring of the runner comprises at least one circumferential groove.

6. A device according to claim 1, wherein the surface of the plate element in contact with the radial flaring of the runner comprises a geometric configuration in sectors.

7. A device according to claim 1, wherein the surface of the plate element in contact with the radial flaring of the runner comprises a configuration of sectors defined by radial notches, there being two contiguous notches defining a preferential sector separated by an angle greater than 47.5°.

8. A device according to claim 7, wherein the radial notches comprise two ramps allowing the user to have a sensation of two steps in each of the operating directions.

9. A device according to claim 1, wherein the surface of the radial flaring of the runner in contact with the surface of the plate element is smooth.

10. Device according to claim 1, wherein the surface of the radial flaring of the runner in contact with the surface of the plate element comprises at least one protrusion.

11. A device according to claim 1, comprising an operating knob couplable on the runner.

12. A device according to claim 11, comprising at least one elastic element which is attached at one end to the runner and is attached at the other end to the operating knob.

13. A device according to claim 11, wherein the operating knob comprises a plurality of geometric irregularities at its upper end.

14. A device according to claim 11, wherein the operating knob comprises a series of protrusions on its side surface, contiguous smooth areas being defined between two protrusions such that the protrusions or the smooth areas could be acted on.

15. A device according to claim 1, comprising an elastic part at least partially covering the device according to claim 1.
